(19) United States
(12) Patent Application Publication
(10) Pub. No.: US 2025/0297757 A1
(43) Pub. Date: Sep. 25, 2025

(54) CLOUD-BASED REMOTE MANAGEMENT OF TEMPERATURE BANDS FOR ENERGY SAVINGS

(71) Applicant: Honeywell International Inc., Charlotte, NC (US)

(72) Inventors: Aditi Choudhary, Pune (IN); Bhavesh Gupta, Cumming, GA (US); Haresh Chouksey, Pune (IN); Narayanaswamy Bandi, Bangalore (IN); Ryan Gardner, Niantic, CT (US); Sachin Gavhane, Pune (IN); Santhosh Kumar Shivabeerappa, Bengaluru (IN); Vishnu MR, Malappuram (IN); Michael Sobanko, Oakdale, CT (US); Devanshu Dugar, Kolkata (IN); Neha Jaitpal, San Diego, CA (US)

(21) Appl. No.: 19/082,777

(22) Filed: Mar. 18, 2025

(30) Foreign Application Priority Data
Mar. 19, 2024 (IN) 202411020468

(51) Int. Cl. F24F 11/47; F24F 11/523; F24F 11/58; F24F 11/65; F24F 120/10; G06Q 50/06; G06Q 50/12

(52) U.S. Cl. CPC F24F 11/47; F24F 11/523; F24F 11/58; F24F 11/65; G06Q 50/06; G06Q 50/12; F24F 2120/10

(57) ABSTRACT

A system and method for controlling temperature in hotel guest rooms using a thermostat with multiple temperature deadband configurations. The thermostat connects to a server and includes configuration parameters for comfort temperature setpoint and temperature deadbands for different room states—rented/occupied, rented/unoccupied, and unrented. The server displays these parameters via a user interface allowing a facility manager to modify the deadbands within enforced limits. The thermostat controls room temperature using the appropriate deadband based on room occupancy and rental status, determined through occupancy sensors and property management system integration. The system can recommend deadband changes based on historical temperature data and outdoor conditions, while calculating estimated energy savings. Configuration parameters can be downloaded to one or multiple thermostats across guest rooms facility-wide.

### RELATED APPLICATIONS

This application claims the benefit of Indian Provisional Application No. 202411020468, filed Mar. 19, 2024, which application is incorporated by reference in its entirety.

### TECHNICAL FIELD

The present disclosure relates generally to Heating, Ventilating, and Air Conditioning (HVAC) systems, and more particularly to remote management of temperature bands for energy savings within HVAC systems.

### BACKGROUND

A property such as a hotel can include a number of guest rooms. At any given time, some of the guest rooms are rented and occupied. Some of the guest rooms are rented and unoccupied. Some of the guest rooms are unrented. When a guest room is rented and occupied, temperature in the guest room is controlled to a temperature setpoint that is chosen for comfort. When a guest room is rented but not occupied, someone may return to the guest room at any time, so the temperature in the guest room is allowed to drift from the comfort temperature setpoint but not so far that the temperature will take too long to recover when the person returns to the guest room. When a guest room is unrented, nobody will be returning to the guest room until some point after the guest room is rented. Accordingly, the temperature in the unrented guest room can be allowed to drift further from the comfort temperature setpoint because the HVAC system will have more time to recover once the HVAC system is informed that the guest room has become rented and may be occupied soon.

It will be appreciated that energy savings can be achieved by allowing guest room temperatures to drift from the comfort temperature setpoint anytime a particular guest room is unoccupied. Because a hotel can include hundreds or even thousands of guest rooms, it can be difficult to manually adjust temperatures in each of the guest rooms based on their rented/unrented and occupied/unoccupied status. What would be desirable are methods and systems for allowing a hotel operator to efficiently define temperature deadbands that dictate how far an actual temperature within any particular guest room is allowed to vary from a comfort temperature setpoint based on the rented/unrented and occupied/unoccupied status of that guest room.

### SUMMARY

The present disclosure relates generally to Heating, Ventilating, and Air Conditioning (HVAC) systems, and more particularly to remote management of temperature bands for energy savings within HVAC systems. An example may be found in a method of controlling a temperature in a guest room of a hotel facility. The guest room includes a thermostat with a plurality of configuration parameters including a comfort temperature setpoint, a rented and occupied temperature deadband about the comfort temperature setpoint, a rented and unoccupied temperature deadband about the comfort temperature setpoint, and an unrented temperature deadband about the comfort temperature setpoint. The rented and unoccupied temperature deadband is broader than the rented and occupied temperature deadband, and the unrented temperature deadband is broader than the rented and unoccupied temperature deadband. In this example, the thermostat is operatively coupled to a server over a network. The method includes the server displaying via a user interface one or more of the plurality of configuration parameters of the thermostat including one or more of the rented and unoccupied temperature deadband and the unrented temperature deadband. The server allows a facility manager of the hotel facility to modify one or more of the rented and unoccupied temperature deadband and the unrented temperature deadband via the user interface. The server downloads one or more of the plurality of configuration parameters to the thermostat including one or more of the rented and unoccupied temperature deadband and the unrented temperature deadband. The thermostat then controls the temperature in the guest room using the rented and occupied temperature deadband when the guest room is rented and occupied, the rented and unoccupied temperature deadband when the guest room is rented and unoccupied, and the unrented temperature deadband when the guest room is unrented.

Another example may be found in a system for controlling a temperature in a guest room of a hotel facility. The system includes a thermostat that is associated with the guest room and is operatively coupled to heating and/or cooling equipment of the hotel facility for heating and/or cooling the guest room. The thermostat has a plurality of configuration parameters including a comfort temperature setpoint, a rented and occupied temperature deadband about the comfort temperature setpoint, a rented and unoccupied temperature deadband about the comfort temperature setpoint, and a unrented temperature deadband about the comfort temperature setpoint, wherein the rented and unoccupied temperature deadband is broader than the rented and occupied temperature deadband, and the unrented temperature deadband is broader than the rented and unoccupied temperature deadband. The illustrative system includes a display and a server that is operatively coupled to the thermostat and the display. The server is configured to display a user interface on the display that includes one or more of the plurality of configuration parameters of the thermostat including one or more of the rented and unoccupied temperature deadband and the unrented temperature deadband. The server is configured to receive input from a facility manager of the hotel facility via the user interface to modify one or more of the rented and unoccupied temperature deadband and the unrented temperature deadband via the user interface. The server is configured to download one or more of the plurality of configuration parameters to the thermostat including one or more of the rented and unoccupied temperature deadband and the unrented temperature deadband. The thermostat is configured to control the temperature in the guest room using the rented and occupied temperature deadband when the guest room is rented and occupied, the rented and unoccupied temperature deadband when the guest room is rented and unoccupied, and the unrented temperature deadband when the guest room is unrented.

Another example may be found in a non-transitory computer readable medium storing instructions. When the instructions are executed by one or more processors, the one or more processors are caused to display via a user interface one or more of a plurality of configuration parameters of a thermostat of a guest room of a hotel facility including one or more of a rented and unoccupied temperature deadband and a unrented temperature deadband. The one or more processors are caused to receive input from a facility manager of the hotel facility via the user interface to modify one or more of the rented and unoccupied temperature deadband and the unrented temperature deadband via the user interface. The one or more processors are caused to download one or more of the plurality of configuration parameters to the thermostat including one or more of the rented and unoccupied temperature deadband and the unrented temperature deadband for use by the thermostat during subsequent operation of the thermostat.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system for controlling a temperature in a guest room of a hotel facility;

FIG. 2 is a schematic block diagram showing an example of the illustrative system of FIG. 1;

FIGS. 3A, 3B, and 3C are flow diagrams that together show an illustrative method for controlling a temperature in a guest room of a hotel facility;

FIG. 4 is a flow diagram that shows an illustrative series of steps that may be carried out by one or more processors when the one or more processors execute instructions that are stored on a non-transient, computer-readable storage medium; and

FIGS. 5 through 9 provide illustrative screen captures.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/of” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

In some cases, a temperature band management feature of a cloud supervisor may enable on-site hotel staff to securely configure and manage temperature bands of temperature control devices (e.g. thermostats). Such a system may offer EMS (Energy Management System) devices and software, which can help reduce energy costs and contribute to quicker Return on Investment (ROI). From simple to complex, these systems may tailor guestroom experiences with energy management and hospitality Internet-of-Things (IoT) to save energy costs without compromising guest comfort. Temperature band management functionality can allow on-site hotel staff of a cloud supervisor to manage and configure temperature band parameters for some and/or all of the thermostats installed in a hotel in a quick, intuitive and easy manner. Commands can be sent in a broadcast and/or unicast fashion with various combinations, such as: (1) send one or more temperature band parameter values to a single room; (2) send one or more temperature band parameter values to all rooms; and (3) send one or more temperature band parameter values to a selected group of rooms.

In some cases, smart analytics may be used to suggest recommended temperature band parameter values/changes for each of the rooms. Recommended temperature band parameter values/changes may be calculated based on a room profile of each room, as well as current and/or historical data associated with the room and/or hotel. In some cases, the recommended temperature band parameter values/changes may be calculated using regression analysis and/or Machine Learning (ML). The room profile of each room may be based on a number of room parameters including, for example, the size of the room, the direction that the room is facing (e.g. whether the room is facing towards the sun direction), the distance the room is from the chiller, the current season (fall, winter, spring or fall), and the geographical location of the hotel (e.g. latitude/longitude). These are just examples. In some cases, the facility manager may quickly adopt some or all of the recommended temperature band parameter values/changes for one or more of the rooms, potentially saving significant energy while still maintaining guest comfort.

In some cases, based on the recommended temperature band parameter values/changes for a room, the system may project energy saving, sometimes as a percent of projected total HVAC energy consumption of the hotel. This may help the facility manager understand the projected impact of the recommended temperature band parameter values/changes on energy consumption and/or guest comfort. In some cases, the facility manager will have the option to ignore the recommended temperature band parameter values/changes and instead provide manual override temperature band parameter values. In some cases, the system may project energy saving and/or impact to guest comfort of the manual override values.

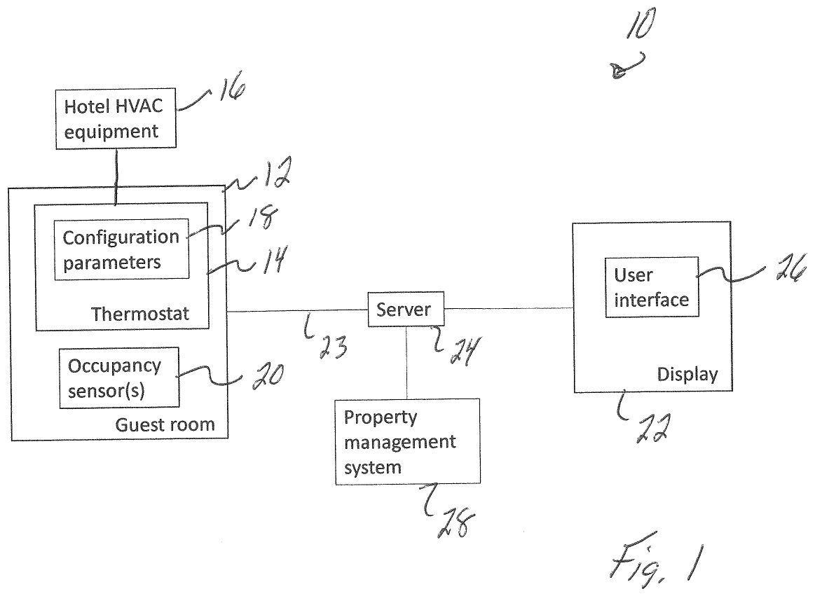

FIG. 1 is a schematic block diagram showing an illustrative system 10 for controlling a temperature in a guest room 12 of a hotel facility. While a single guest room 12 is shown, it will be appreciated that a hotel facility may include tens, hundreds, or even thousands of guest rooms 12. Each guest room 12 includes a thermostat 14 that is associated with the guest room 12. The thermostat 14 is operatively coupled to hotel HVAC (heating, ventilating and air conditioning) equipment 16. In some facilities, the hotel HVAC equipment 16 may provide conditioned air or conditioned water to all of the guest rooms 12 in the hotel. In some cases, the hotel HVAC equipment 16 may be guest room-specific (e.g. mini-split HVAC system). In this example, the thermostat 14 includes a number of configuration parameters 18 that the thermostat 14 may rely upon when operating the hotel HVAC equipment 16. The configuration parameters 18 may include, for example, a comfort temperature setpoint, a rented and occupied temperature deadband about the comfort temperature setpoint, a rented and unoccupied temperature deadband about the comfort temperature setpoint, and a unrented temperature deadband about the comfort temperature setpoint. In some cases, the rented and unoccupied temperature deadband is broader than the rented and occupied temperature deadband, and the unrented temperature deadband is broader than the rented and unoccupied temperature deadband. In some cases, for example, the rented and occupied temperature deadband may be defined by the comfort temperature ±1 degree F. In some cases, the rented and unoccupied temperature deadband may be defined by the comfort temperature ±2 degrees F. In some cases, the unrented temperature deadband may be defined by the comfort temperature ±4 degrees F. These are just examples, and other deadband dimensions are contemplated.

In some cases, the thermostat 14 may be operably coupled with one or more occupancy sensors 20 that are disposed within the guest room 12. The occupancy sensors 20 may include motion sensors such as PIR (passive infrared) sensors, for example. The occupancy sensors 20 may inform the thermostat 14 when the guest room 12 is occupied and when it is unoccupied. The illustrative system 10 includes a display 22 and a server 24 that is operatively coupled to the thermostat 14 and to the display 22. In some cases, the display 22 may be configured to display a user interface (UI) 26. In some cases, the server 24 may be operably coupled with a property management system 28 that is able to provide the thermostat 14 with a room rent status message informing the thermostat 14 when the guest room 12 is rented and when the guest room 12 is not rented.

In some cases, the thermostat 14 may be configured to receive one or more outputs from the one or more occupancy sensors 20 associated with the guest room 12 and to determine whether the guest room 12 is occupied or unoccupied based at least in part on the one or more outputs from the one or more occupancy sensors 20 that are associated with the guest room 12.

In some cases, the server 24 may be configured to display the user interface 26 on the display 22, wherein the user interface 26 shows one or more of the plurality of configuration parameters 18 of the thermostat 14 including one or more of the rented and unoccupied temperature deadband and the unrented temperature deadband. The server 24 may be configured to receive input from a facility manager of the hotel facility via the user interface 26 to modify one or more of the rented and unoccupied temperature deadband and the unrented temperature deadband via the user interface 26. In some cases, the server 24 may be configured to download one or more of the plurality of configuration parameters 18 to the thermostat 14 including one or more of the rented and unoccupied temperature deadband and the unrented temperature deadband. When the guest room 12 is rented and occupied, the thermostat 14 is configured to control the temperature in the guest room 12 using the rented and occupied temperature deadband. When the guest room 12 is rented and unoccupied, the thermostat 14 is configured to control the temperature in the guest room 12 using the rented and unoccupied temperature deadband when the guest room is rented and unoccupied. When the guest room 12 is unrented, the thermostat 14 is configured to control the temperature in the guest room 12 using the unrented temperature deadband.

In some cases, the server 24 may be configured to enforce an upper limit and/or lower limit to the rented and unoccupied temperature deadband when receiving input from the facility manager to modify the rented and unoccupied temperature deadband via the user interface 26. In some cases, the server 24 may be configured to enforce an upper limit and/or lower limit to the unrented temperature deadband when receiving input from the facility manager to modify the unrented temperature deadband via the user interface 26.

In some cases, the server 24 may be configured to determine a recommended change to one or more of the rented and unoccupied temperature deadband and the unrented temperature deadband. In some cases, receiving input from the facility manager of the hotel facility via the user interface 26 to modify one or more of the rented and unoccupied temperature deadband and the unrented temperature deadband via the user interface 26 may include accepting the recommended change. In some cases, the server 24 may be configured to determine a measure of an estimated energy savings of the recommended change, and to display the measure of the estimated energy savings on the user interface 26. In some cases, the server 24 may be configured to download one or more of the plurality of configuration parameters 18 of the thermostat 14 including one or more of the rented and unoccupied temperature deadband and the unrented temperature deadband to the thermostat 14 and to selected ones (or all) of other thermostats of each of a plurality of other guest rooms of the hotel facility. In some cases, the thermostat 14 is coupled to the server 24 via a network 23. The network 23 may be a wired network, a wireless network, or a mesh network. The network 23 may include features of one or more of a wired network, a wireless network, and a mesh network.

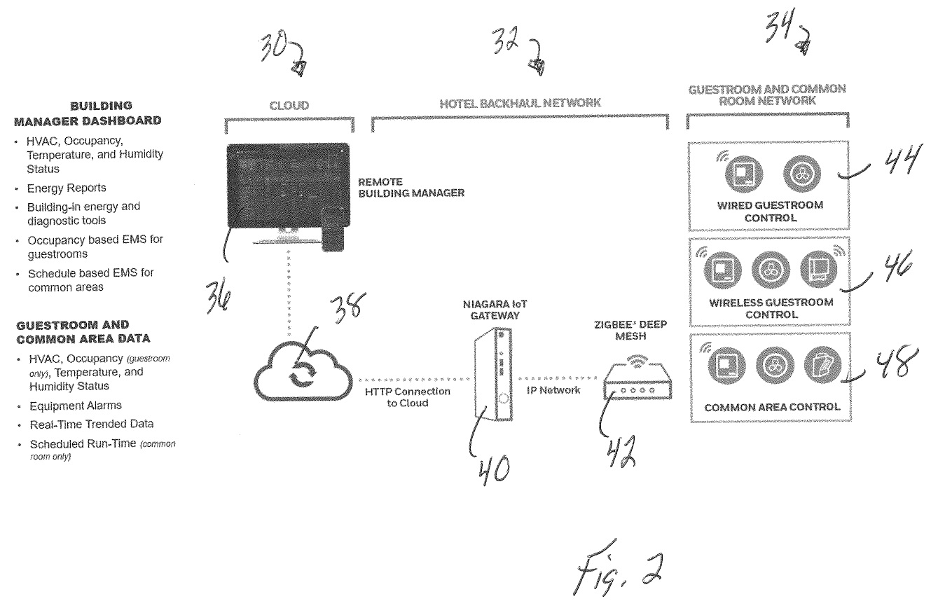

FIG. 2 is a schematic block diagram showing an example of the illustrative system of FIG. 1. In FIG. 2, the illustrative system includes a cloud-based portion 30, a hotel network portion 32, and a guestroom and common room network 34. The cloud-based portion 30 connects a remote building manager 36, which may be located within the hotel or may be remotely located, with a cloud-based system 38. The hotel network portion 32 may include one or more gateways 40 that are configured to communicate with the cloud-based system 38 as well as forming an IP network with a mesh network gateway 42. The guestroom and common room network 34, which is disposed locally within the hotel, for example, may be considered as including wired guestroom controls 44, wireless guestroom controls 46, and/or common area controls 48 which may be wired or wireless.

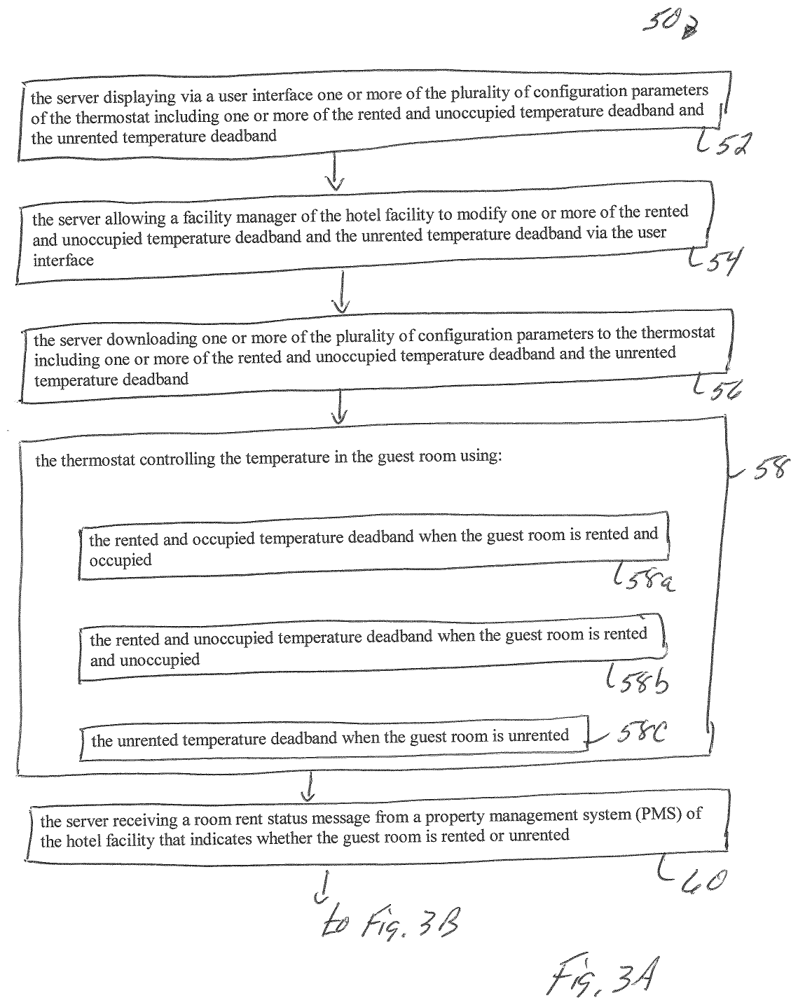

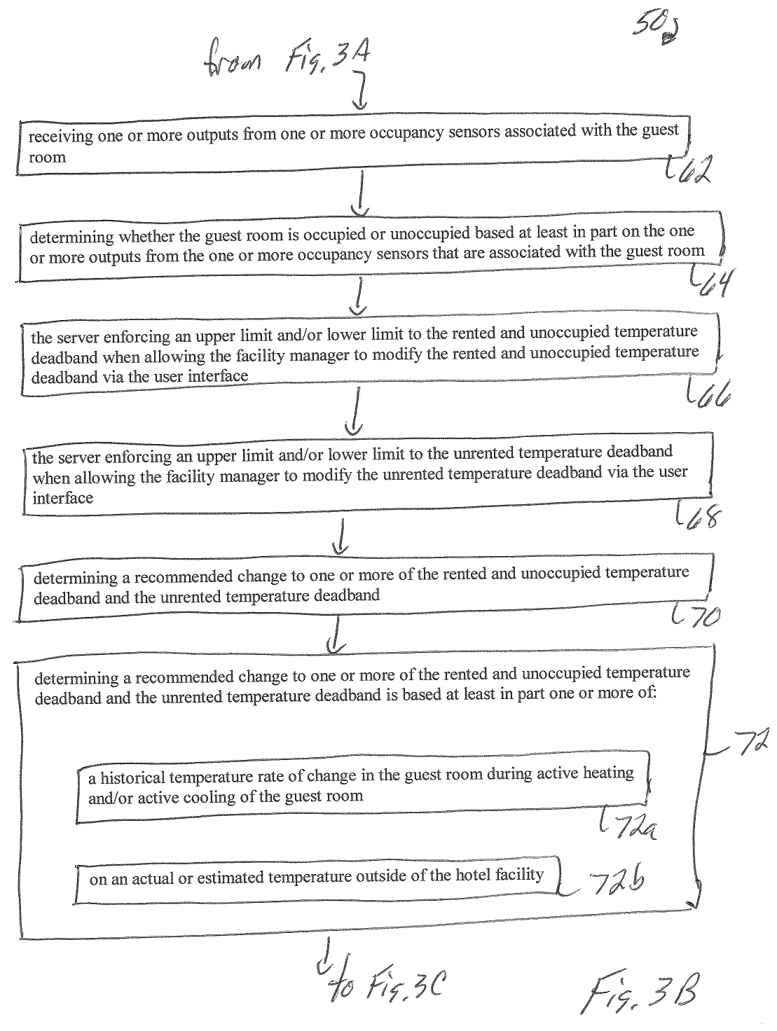

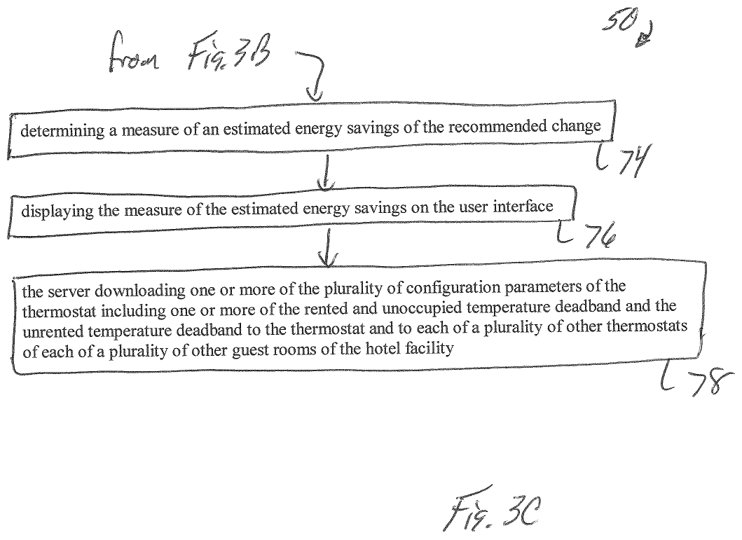

FIGS. 3A, 3B, and 3C are flow diagrams that together show an illustrative method 50 of controlling a temperature in a guest room (such as the guest room 12) of a hotel facility. The guest room includes a thermostat (such as the thermostat 14) with a plurality of configuration parameters (such as the configuration parameters 18) including a comfort temperature setpoint, a rented and occupied temperature deadband about the comfort temperature setpoint, a rented and unoccupied temperature deadband about the comfort temperature setpoint, and an unrented temperature deadband about the comfort temperature setpoint. The rented and unoccupied temperature deadband is broader than the rented and occupied temperature deadband, and the unrented temperature deadband is broader than the rented and unoccupied temperature deadband. The thermostat is operatively coupled to a server (such as the server 24) over a network (such as the network 23). The method 50 includes the server displaying via a user interface (such as the user interface 26) one or more of the plurality of configuration parameters of the thermostat including one or more of the rented and unoccupied temperature deadband and the unrented temperature deadband, as indicated at block 52. The server allows a facility manager of the hotel facility to modify one or more of the rented and unoccupied temperature deadband and the unrented temperature deadband via the user interface, as indicated at block 54. The facility manager may make this change from within the hotel facility, or remotely from the facility. The server downloads one or more of the plurality of configuration parameters (e.g. updated configuration parameters) to the thermostat including one or more of the rented and unoccupied temperature deadband and the unrented temperature deadband, as indicated at block 56.

In some cases, the thermostat controls the temperature in the guest room, as indicated at block 58. In some cases, the thermostat controls the temperature in the guest room using the rented and occupied temperature deadband when the guest room is rented and occupied, as indicated at block 58a. In some cases, the thermostat controls the temperature in the guest room using the rented and unoccupied temperature deadband when the guest room is rented and unoccupied, as indicated at block 58b. In some cases, the thermostat controls the temperature in the guest room using the unrented temperature deadband when the guest room is unrented, as indicated at block 58c. In some cases, the server receives a room rent status message from a property management system (PMS) of the hotel facility (such as the PMS system 28) that indicates whether the guest room is rented or unrented, as indicated at block 60.

Continuing on FIG. 3B, the method 50 may include receiving one or more outputs from one or more occupancy sensors (such as the occupancy sensors 20) associated with the guest room, as indicated at block 62. A determination is made as to whether the guest room is occupied or unoccupied based at least in part on the one or more outputs from the one or more occupancy sensors that are associated with the guest room, as indicated at block 64.

In some cases, the server enforces an upper limit and/or lower limit to the rented and unoccupied temperature deadband while the facility manager is allowed to modify the rented and unoccupied temperature deadband via the user interface, as indicated at block 66. In some cases, the server enforces an upper limit and/or lower limit to the unrented temperature deadband while the facility manager is allowed to modify the unrented temperature deadband via the user interface, as indicated at block 68.

In some cases, the method 50 may include determining a recommended change to one or more of the rented and unoccupied temperature deadband and the unrented temperature deadband, as indicated at block 70. In some cases, determining a recommended change to one or more of the rented and unoccupied temperature deadband and the unrented temperature deadband may be based at least in part on a room profile, as well as current and/or historical data associated with the room and/or hotel. In some cases, the recommended temperature band parameter values may be calculated using regression analysis and/or Machine Learning (ML). The room profile of each room may be based on a number of room parameters including, for example, the size of the room, the direction that the room is facing (e.g. whether the room is facing towards the sun direction), the distance the room is from the chiller, the current season (fall, winter, spring or fall), and the geographical location of the hotel (e.g. latitude/longitude). These are just examples.

In some cases, determining the recommended change to one or more of the rented and unoccupied temperature deadband and the unrented temperature deadband may be based on one or more factors, as indicated at block 72. The one or more factors may include a historical temperature rate of change in the guest room during active heating and/or active cooling of the guest room, as indicated at block 72a. The one or more factors may include an actual or estimated temperature outside of the hotel facility, as indicated at block 72b. In some cases, the one or more factors may be part of the room profile of the respective room.

Continuing on FIG. 3C, the method 50 may include determining a measure of an estimated energy savings of the recommended change, as indicated at block 74. The measure of the estimated energy savings may be displayed on the user interface, as indicated at block 76. In some cases, the method 50 may include the server downloading one or more of the plurality of configuration parameters of the thermostat including one or more of the rented and unoccupied temperature deadband and the unrented temperature deadband to the thermostat and to one or more of the other thermostats of each of a plurality of other guest rooms of the hotel facility, as indicated at block 78.

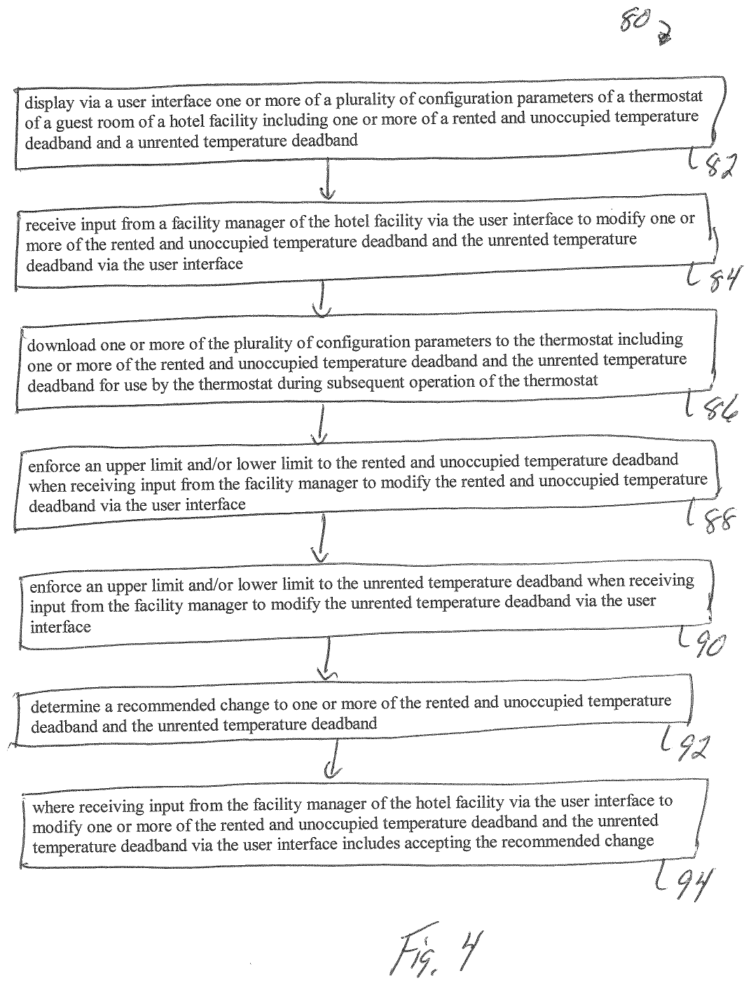

FIG. 4 is a flow diagram showing an illustrative series of steps 80 that may be carried out by one or more processors when the one or more processors are executing instructions that are stored on a non-transitory computer-readable storage medium. The one or more processors may be part of the server 24, for example. The one or more processors are caused to display via a user interface one or more of a plurality of configuration parameters of a thermostat of a guest room of a hotel facility including one or more of a rented and unoccupied temperature deadband and an unrented temperature deadband, as indicated at block 82. The one or more processors are caused to receive input from a facility manager of the hotel facility via the user interface to modify one or more of the rented and unoccupied temperature deadband and the unrented temperature deadband via the user interface, as indicated at block 84. The one or more processors are caused to download one or more of the plurality of configuration parameters to the thermostat including one or more of the rented and unoccupied temperature deadband and the unrented temperature deadband for use by the thermostat during subsequent operation of the thermostat, as indicated at block 86.

In some cases, the one or more processors may be caused to enforce an upper limit and/or lower limit to the rented and unoccupied temperature deadband when receiving input from the facility manager to modify the rented and unoccupied temperature deadband via the user interface, as indicated at block 88. In some cases, the one or more processors are caused to enforce an upper limit and/or lower limit to the unrented temperature deadband when receiving input from the facility manager to modify the unrented temperature deadband via the user interface, as indicated at block 90. In some cases, the one or more processors are caused to determine a recommended change to one or more of the rented and unoccupied temperature deadband and the unrented temperature deadband, as indicated at block 92. In some cases, the one or more processors may be caused to accept the recommended change when receiving input from the facility manager of the hotel facility via the user interface to modify one or more of the rented and unoccupied temperature deadband and the unrented temperature deadband via the user interface, as indicated at block 94.

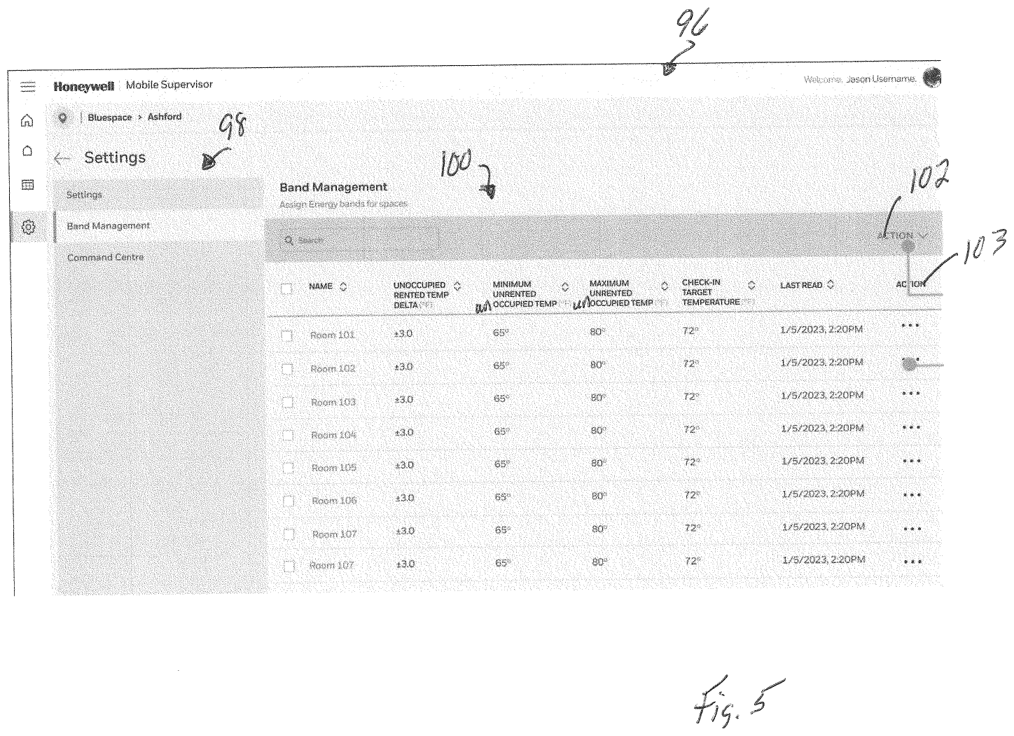

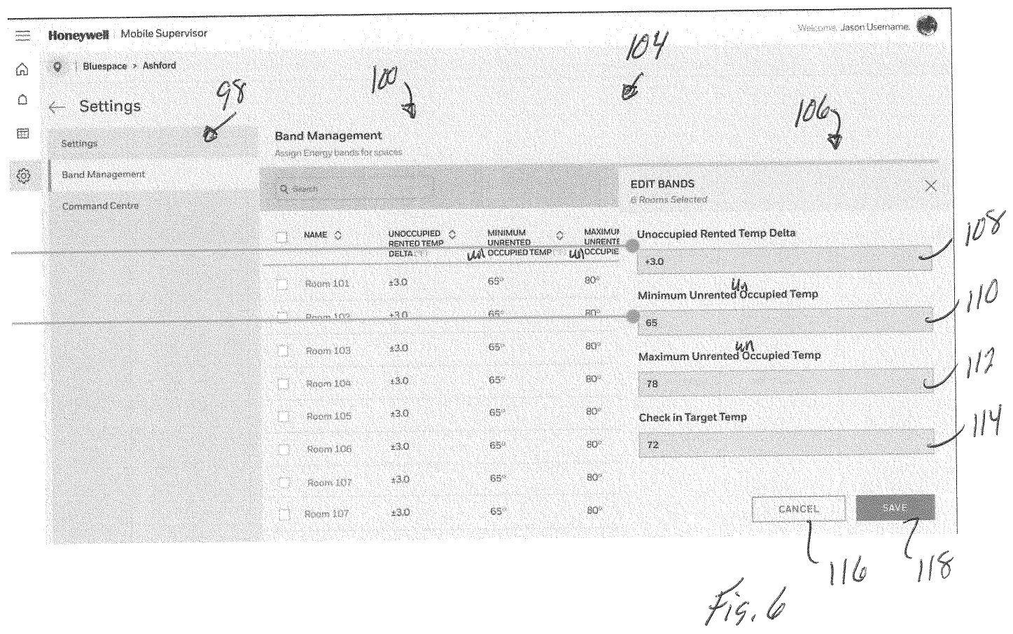

FIG. 5 is a screen capture showing an illustrative screen 96 that may be generated by the server 24 and displayed on the user interface 26. The screen 96 includes a settings section 98 and a band management section 100. The band management section 100 lists a number of guest rooms of a hotel and ranges for how far the temperature in those guest rooms are allowed to deviate from a check-in target temperature (e.g. comfort temperature setpoint), depending on whether the particular guest room is rented or unrented, and is occupied or unoccupied. The screen 96 includes an Actions button 102 that allows a user to either read values or edit the temperature band values. The band management section 100 includes an Actions column 103 that can display information such as whether the displayed values have taken effect, or if their download and/or activation are still in progress. Selecting the Actions button 102 and selecting edit bands causes a screen 104 to be generated and displayed, as indicated in FIG. 6.

FIG. 6 is a screen capture showing the illustrative screen 104, which includes a popup 106 floating over what is otherwise screen 96 of FIG. 5. The popup 106 allows a user to edit the temperature bands, and includes an unoccupied rented temperature band window 108, a minimum unrented unoccupied temperature window 110, a maximum unrented unoccupied temperature window 112, and a check-in target temperature window 114. The windows 108, 110, 112, and 114 may be used to adjust the respective temperature band values. The popup 106 includes a CANCEL button 116 that may be used to cancel the edits, and a SAVE button 118 that may be used to save the updated values.

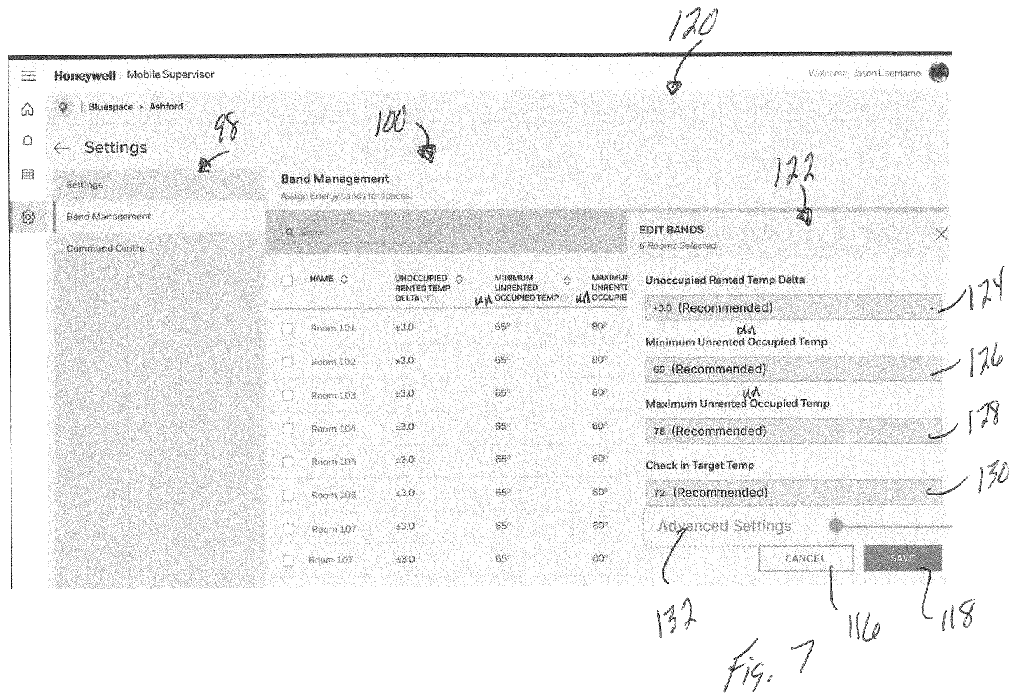

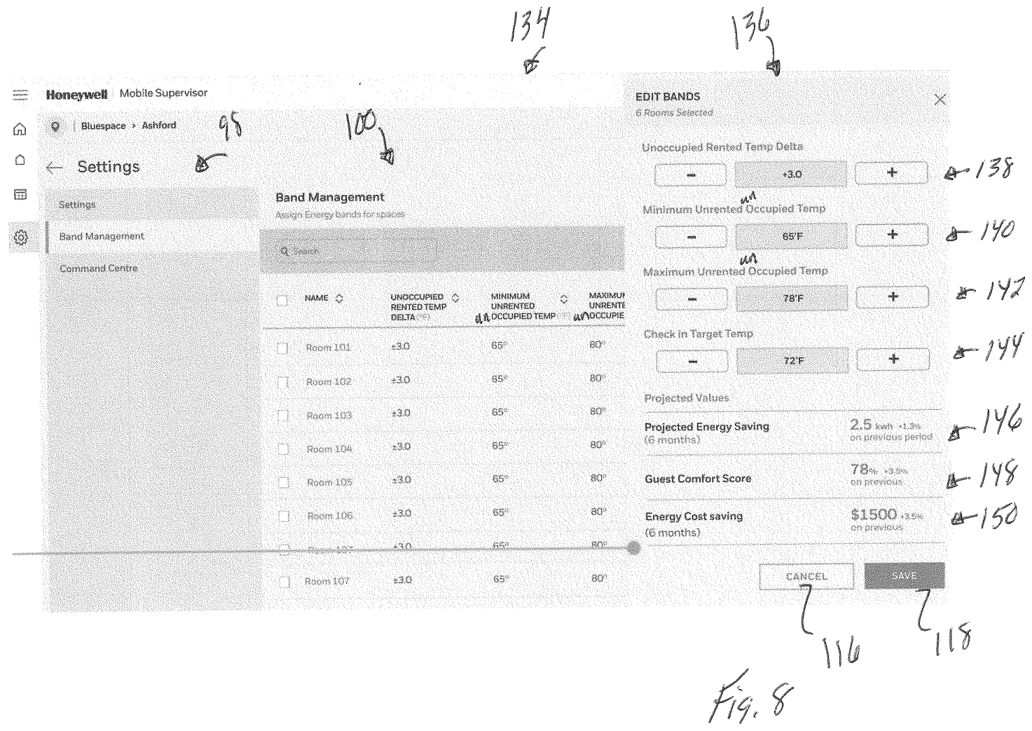

FIG. 7 is a screen capture showing an illustrative screen 120 that may be generated by the server 24 and displayed on the user interface 26. The screen 120 includes a popup 122 floating over what is otherwise screen 96 of FIG. 5. The popup 122 displays recommended values, and allows a user to edit the temperature bands. The recommended values may be calculated as described herein. The popup 122 includes an unoccupied rented temperature band window 124, a minimum unrented unoccupied temperature window 126, a maximum unrented unoccupied temperature window 128, and a check-in target temperature window 130. The windows 124, 126, 128, and 130 may be used to adjust the respective temperature band values. The popup 122 includes the CANCEL button 116 that may be used to cancel the edits, and the SAVE button 118 that may be used to save the updated values. In some cases, the popup 122 may also include an ADVANCED SETTINGS button 132, which if selected causes a screen 134 to be displayed, as shown in FIG. 8.

FIG. 8 is a screen capture showing the illustrative screen 134 that may be generated by the server 24 and displayed on the user interface 26. The screen 134 includes a popup 136 floating over what is otherwise screen 96 of FIG. 5. The popup 136 displays each of several temperature values along with MINUS and PLUS buttons for adjusting each of the displayed temperature values. There is a MINUS button and a PLUS button for adjusting an unoccupied rented temperature band 138, a MINUS button and a PLUS button for adjusting a minimum unrented unoccupied temperature 140, a MINUS button and a PLUS button for adjusting a maximum unrented unoccupied temperature 142, and a MINUS button and a PLUS button for adjusting a check-in target temperature 144. The popup 136 also includes a projected energy savings 146, a guest comfort score 148, and an energy cost savings 150 that is projected to result from the displayed temperature values. Accordingly, the user is able to see the projected energy savings and energy cost savings that may result from changing one or more of the values, as well as how that change may impact the guest comfort. The popup 136 also includes the CANCEL button 116 that may be used to cancel the edits, and the SAVE button 118 that may be used to save the updated values.

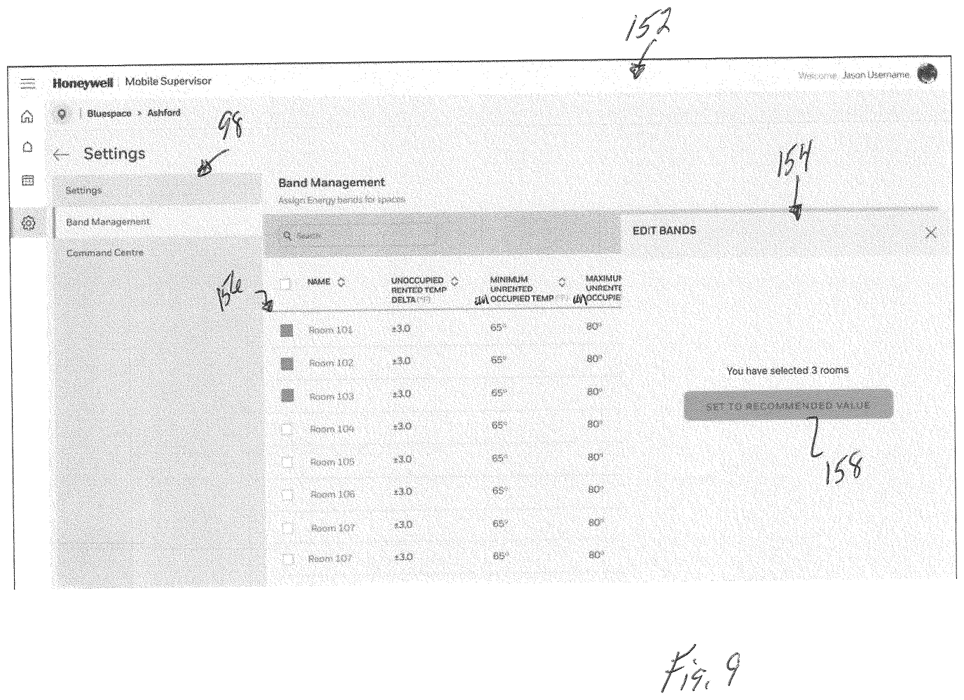

FIG. 9 is a screen capture showing an illustrative screen 152 that may be generated by the server 24 and displayed by the user interface 26. The screen 152 is similar to the screen 96, but includes a popup 154 resulting from the user selecting several of the guest rooms by clicking on selection boxes 156. By selecting the specific guest rooms, the user is choosing to set these guest rooms to the recommended values (or other values), as indicated by an information window 158.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method of controlling a temperature in a guest room of a hotel facility, wherein the guest room includes a thermostat with a plurality of configuration parameters including a comfort temperature setpoint, a rented and occupied temperature deadband about the comfort temperature setpoint, a rented and unoccupied temperature deadband about the comfort temperature setpoint, and an unrented temperature deadband about the comfort temperature setpoint, wherein the rented and unoccupied temperature deadband is broader than the rented and occupied temperature deadband, and the unrented temperature deadband is broader than the rented and unoccupied temperature deadband, wherein the thermostat is operatively coupled to a server over a network, the method comprising:
the server displaying via a user interface one or more of the plurality of configuration parameters of the thermostat including one or more of the rented and unoccupied temperature deadband and the unrented temperature deadband;
the server allowing a facility manager of the hotel facility to modify one or more of the rented and unoccupied temperature deadband and the unrented temperature deadband via the user interface;
the server downloading one or more of the plurality of configuration parameters to the thermostat including one or more of the rented and unoccupied temperature deadband and the unrented temperature deadband;
the thermostat controlling the temperature in the guest room using:
the rented and occupied temperature deadband when the guest room is rented and occupied;
the rented and unoccupied temperature deadband when the guest room is rented and unoccupied; and
the unrented temperature deadband when the guest room is unrented.

2. The method of claim 1, comprising:
the server receiving a room rent status message from a property management system (PMS) of the hotel facility that indicates whether the guest room is rented or unrented.

3. The method of claim 1, comprising:
receiving one or more outputs from one or more occupancy sensors associated with the guest room; and
determining whether the guest room is occupied or unoccupied based at least in part on the one or more outputs from the one or more occupancy sensors that are associated with the guest room.

4. The method of claim 1, wherein:
the server enforcing an upper limit and/or lower limit to the rented and unoccupied temperature deadband when allowing the facility manager to modify the rented and unoccupied temperature deadband via the user interface.

5. The method of claim 1, wherein:
the server enforcing an upper limit and/or lower limit to the unrented temperature deadband when allowing the facility manager to modify the unrented temperature deadband via the user interface.

6. The method of claim 1, comprising:
determining a recommended change to one or more of the rented and unoccupied temperature deadband and the unrented temperature deadband.

7. The method of claim 6, wherein the recommended change to one or more of the rented and unoccupied temperature deadband and the unrented temperature deadband is based at least in part one or more of:
a historical temperature rate of change in the guest room during active heating and/or active cooling of the guest room; and
on an actual or estimated temperature outside of the hotel facility.

8. The method of claim 6, wherein the recommended change provides an estimated energy savings of the heating and/or cooling of the guest room of the hotel facility.

9. The method of claim 8, comprising:
determining a measure of an estimated energy savings of the recommended change; and
displaying the measure of the estimated energy savings on the user interface.

10. The method of claim 1, wherein:
the server downloading one or more of the plurality of configuration parameters of the thermostat including one or more of the rented and unoccupied temperature deadband and the unrented temperature deadband to the thermostat and to each of a plurality of other thermostats of each of a plurality of other guest rooms of the hotel facility.

11. A system for controlling a temperature in a guest room of a hotel facility, the system comprising:
a thermostat associated with the guest room, the thermostat operatively coupled to heating and/or cooling equipment of the hotel facility for heating and/or cooling the guest room, the thermostat having a plurality of configuration parameters including a comfort temperature setpoint, a rented and occupied temperature deadband about the comfort temperature setpoint, a rented and unoccupied temperature deadband about the comfort temperature setpoint, and a unrented temperature deadband about the comfort temperature setpoint, wherein the rented and unoccupied temperature deadband is broader than the rented and occupied temperature deadband, and the unrented temperature deadband is broader than the rented and unoccupied temperature deadband;
a display;
a server operatively coupled to the thermostat and the display, the server configured to:
display a user interface on the display that displays one or more of the plurality of configuration parameters of the thermostat including one or more of the rented and unoccupied temperature deadband and the unrented temperature deadband;
receive input from a facility manager of the hotel facility via the user interface to modify one or more of the rented and unoccupied temperature deadband and the unrented temperature deadband via the user interface;
download one or more of the plurality of configuration parameters to the thermostat including one or more of the rented and unoccupied temperature deadband and the unrented temperature deadband;
the thermostat is configured to control the temperature in the guest room using:
the rented and occupied temperature deadband when the guest room is rented and occupied;
the rented and unoccupied temperature deadband when the guest room is rented and unoccupied; and
the unrented temperature deadband when the guest room is unrented.

12. The system of claim 11, wherein the server is configured to receive a room rent status message from a property management system (PMS) of the hotel facility that indicates whether the guest room is rented or unrented.

13. The system of claim 11, wherein the thermostat is configured to:
receive one or more outputs from one or more occupancy sensors associated with the guest room; and
determine whether the guest room is occupied or unoccupied based at least in part on the one or more outputs from the one or more occupancy sensors that are associated with the guest room.

14. The system of claim 11, wherein the server is configured to:
enforce an upper limit and/or lower limit to the rented and unoccupied temperature deadband when receiving input from the facility manager to modify the rented and unoccupied temperature deadband via the user interface; and
enforce an upper limit and/or lower limit to the unrented temperature deadband when receiving input from the facility manager to modify the unrented temperature deadband via the user interface.

15. The system of claim 11, wherein the server is configured to:
determine a recommended change to one or more of the rented and unoccupied temperature deadband and the unrented temperature deadband; and
where receiving input from the facility manager of the hotel facility via the user interface to modify one or more of the rented and unoccupied temperature deadband and the unrented temperature deadband via the user interface comprises accepting the recommended change.

16. The system of claim 15, wherein the server is configured to:
determine a measure of an estimated energy savings of the recommended change; and
displaying the measure of the estimated energy savings on the user interface.

17. The system of claim 11, wherein the server is configured to:
download one or more of the plurality of configuration parameters of the thermostat including one or more of the rented and unoccupied temperature deadband and the unrented temperature deadband to the thermostat and to each of a plurality of other thermostats of each of a plurality of other guest rooms of the hotel facility.

18. A non-transitory computer readable medium storing instructions that when executed by one or more processors causes the one or more processors to:
display via a user interface one or more of a plurality of configuration parameters of a thermostat of a guest room of a hotel facility including one or more of a rented and unoccupied temperature deadband and a unrented temperature deadband;
receive input from a facility manager of the hotel facility via the user interface to modify one or more of the rented and unoccupied temperature deadband and the unrented temperature deadband via the user interface; and
download one or more of the plurality of configuration parameters to the thermostat including one or more of the rented and unoccupied temperature deadband and the unrented temperature deadband for use by the thermostat during subsequent operation of the thermostat.

19. The non-transitory computer readable medium of claim 18, wherein the instructions cause the one or more processors to:
enforce an upper limit and/or lower limit to the rented and unoccupied temperature deadband when receiving input from the facility manager to modify the rented and unoccupied temperature deadband via the user interface; and
enforce an upper limit and/or lower limit to the unrented temperature deadband when receiving input from the facility manager to modify the unrented temperature deadband via the user interface.

20. The non-transitory computer readable medium of claim 18, wherein the instructions cause the one or more processors to:
determine a recommended change to one or more of the rented and unoccupied temperature deadband and the unrented temperature deadband; and
where receiving input from the facility manager of the hotel facility via the user interface to modify one or more of the rented and unoccupied temperature deadband and the unrented temperature deadband via the user interface includes accepting the recommended change.
